(19) United States
(12) Patent Application Publication
(10) Pub. No.: US 2026/0043713 A1
(43) Pub. Date: Feb. 12, 2026

(54) METHOD FOR DETECTING ANOMALIES IN AEROENGINE VARIABLE WORKING CONDITIONS BASED ON MULTI-BAND WAVELET NETWORK

(71) Applicant: XI'AN JIAOTONG UNIVERSITY, Xi'an (CN)

(72) Inventors: Ruqiang Yan, Xi'an (CN); Zuogang Shang, Xi'an (CN); Zhibin Zhao, Xi'an (CN); Chenye Hu, Xi'an (CN); Xuechun Bai, Xi'an (CN); Chao Teng, Xi'an (CN); Xingwu Zhang, Xi'an (CN); Xuefeng Chen, Xi'an (CN)

(21) Appl. No.: 18/945,049

(22) Filed: Nov. 12, 2024

(30) Foreign Application Priority Data
Aug. 6, 2024 (CN) 2024110748347

(51) Int. Cl. G01M 15/14

(52) U.S. Cl. CPC G01M 15/14

(57) ABSTRACT

The present disclosure discloses a method for detecting anomalies in acroengine variable working conditions based on a multi-band wavelet network, including the steps of: collecting monitoring signals of an acroengine in a healthy state under a plurality of working conditions and corresponding working condition information; constructing and training a multi-band wavelet network using the signals and working conditions; calculating a state monitoring index of the signal using the trained network; determining a monitoring threshold according to the state monitoring index; and determining whether or not the engine is abnormal by comparing the state monitoring indexes of the monitoring signals of the aeroengine under the plurality of working conditions to the monitoring threshold. The present disclosure fully considers the advantages and disadvantages of the signal processing technique with the deep learning network for fault diagnosis.

### CROSS-REFERENCE TO RELATED APPLICATION

This application claims priority from the Chinese patent application 2024110748347 filed Aug. 6, 2024, the content of which are incorporated herein in the entirety by reference.

### TECHNICAL FIELD

The present disclosure belongs to the field of signal processing analysis and fault diagnosis, and in particular relates to a method for detecting anomalies in aeroengine variable working conditions based on a multi-band wavelet network.

### BACKGROUND

As the heart of an aircraft, the reliable operation of the aeroengine is a critical aspect of ensuring flight safety. With the development of artificial intelligence technology, intelligent anomaly detection methods have gradually taken the lead due to their data adaptive capabilities, significantly reducing the need for manual analysis. Although there are already some intelligent anomaly detection algorithms for aeroengines, these acroengines are major equipment, and their safety assurance technology must be sufficiently reliable. However, deep learning-based detection models are data-driven black box models, and their algorithm construction is difficult to achieve the same high stability and reliability as signal processing techniques. Therefore, they cannot meet the requirements of service safety assurance technology for aeroengines.

At the same time, the operating states of the aeroengine include climbing, cruising, landing, and additional maneuvering states, leading to different statistical characteristics of its monitoring signals under different working conditions. Both traditional and intelligent anomaly detection methods primarily focus on stable working conditions, where they model the statistical characteristics of signals under a single working condition to effectively identify abnormal samples. However, when the statistical characteristics of samples change due to variations in working conditions, traditional methods tend to misidentify normal signals as abnormal signals, making them difficult to apply in practical scenarios.

Moreover, the complex structure of an aeroengine leads to intricate signal transmission paths with significant interference. The limited number of vibration measurement points on the engine exacerbates the severe coupling of multi-source signals. These factors result in poor data quality and significant noise interference in the collected data. While deep learning networks can achieve end-to-end automated feature extraction, they lack sufficient noise resistance and are prone to overfitting to noise. In situations with poor data quality and significant noise interference, it is challenging for them to extract fault features. Therefore, they do not possess strong generalization capabilities and are difficult to apply in practical anomaly detection scenarios.

The above information disclosed in the Background section is only for enhancement of understanding of the background of the disclosure and therefore may contain information that does not constitute the prior art that is well known to those of ordinary skill in the art.

### SUMMARY

In view of the shortcomings in the prior art, an objective of the present disclosure is to propose a method for detecting anomalies in aeroengine variable working conditions based on a multi-band wavelet network, which can improve noise resistance, and working condition transformation robustness of anomaly detection by introducing multi-band wavelet transform, threshold denoising, and neural network fitting techniques.

To achieve the above objective, the present disclosure provides the following technical solutions:

A method for detecting anomalies in aeroengine variable working conditions based on a multi-band wavelet network, including the steps of:
S100: collecting monitoring signals of an aeroengine in a healthy state under a plurality of working conditions and corresponding working condition information;
S200: constructing and training a multi-band wavelet network using the monitoring signals and working condition information;
S300: calculating a state monitoring index of the monitoring signal using the trained network;
S400: determining a monitoring threshold according to the state monitoring index; and
S500: determining whether or not the engine is abnormal by comparing the state monitoring indexes of the monitoring signals of the aeroengine under the plurality of working conditions to the monitoring threshold.

The present disclosure also reveals a multi-band wavelet network-based apparatus for detecting aeroengine anomalies under variable working conditions, comprising:
an acquisition component, for collecting monitoring signals of an aeroengine in a healthy state under a plurality of working conditions and corresponding working condition information;
a training component, for constructing and training a multi-band wavelet network using the monitoring signals and working condition information;
a calculating component, for calculating a state monitoring index of the monitoring signal using the trained network;
a threshold determination component, for determining a monitoring threshold according to the state monitoring index; and
an anomaly determination component, for determining whether or not the engine is abnormal by comparing the state monitoring indexes of the monitoring signals of the aeroengine under the plurality of working conditions to the monitoring threshold.

The present disclosure also reveals a multi-band wavelet network-based system for detecting aeroengine anomalies under variable working conditions, comprising:
a target aeroengine of the same type as the one in a healthy state,
the apparatus for detecting aeroengine anomalies under variable working conditions, and
a controller,
wherein,
acquisition component of the apparatus is further used to collect monitoring signals and corresponding working/operating condition information from the target aeroengine under various operating conditions;
calculating component of the apparatus is further used to: take the monitoring signals and corresponding operating condition information collected by the acquisition component as input, and use the trained network to calculate the state monitoring index of the monitoring signals;
anomaly determination component of the apparatus is further used to: based on the state monitoring index calculated by calculating component and the monitoring threshold determined by the threshold determination component of the apparatus, compare the state monitoring index with the monitoring threshold to determine whether the engine is abnormal, and send the judgment result to the controller, wherein,
when the judgment result is normal, the controller sends a first signal to the acquisition component to continue the detection of anomalies in the target aeroengine under variable working conditions;
when the judgment result is abnormal, the controller sends a second signal to an alarm to trigger an alert.

Preferably, wherein, the multi-band wavelet network includes:
a learnable multi-band wavelet decomposition network for acquiring wavelet coefficient representations of the monitoring signal at different scales by performing one-dimensional wavelet multi-scale decomposition on the monitoring signal;
a learnable wavelet thresholding bi-directional contraction function for achieving efficient identification and removal of anomalous coefficients and achieving suppression of noise in the signal by adaptively fitting a distribution range of wavelet coefficients generated by the multi-band wavelet decomposition network in combination with the working condition information; and
a learnable multi-band wavelet reconstruction network for acquiring a reconstructed signal by performing multi-band wavelet reconstruction on the wavelet coefficient processed by the wavelet thresholding bi-directional contraction function.

Preferably, wherein, the monitoring signal is subjected to one-dimensional wavelet convolution by the learnable multi-band wavelet decomposition network, a wavelet decomposition or wavelet packet decomposition mode is used, wherein the multi-band wavelet decomposition of a single node is expressed as:

$${w}_{m} = {h}_{m} * x , \qquad m = 1 , 2 , … , M ,$$

wherein, x is an input signal, i.e., a monitoring signal sample input after segmentation, w is the wavelet coefficient obtained by one-dimensional convolution, * denotes convolution, hn is a learnable wavelet filter satisfying the property requirement of multi-band wavelet transform, which is capable of adaptive learning based on the data, and M is the number of filters used in the layer.

Preferably, wherein, the wavelet coefficient is processed by the learnable wavelet thresholding bi-directional contraction function, which is expressed as:

$${w}^{′} = w [ [ σ ( - t ( w ↓ - l ) ) - σ ( - t ( w ↓ + ( - l + {b}_{l} ) ) ) + σ ( t ( w ↓ - r ) ) - σ ( t ( w ↓ - ( r + {b}_{r} ) ) ) ] ,$$

wherein, σ is a sigmoid activation function, w↓ is a down-sampled wavelet coefficient obtained by the multi-band wavelet decomposition network via the wavelet decomposition or wavelet packet decomposition mode, l is a left threshold point, bₗ is a band-pass range of a left threshold function, r is a right threshold point, bᵣ is a band-pass range of a right threshold function, the threshold points and the band-pass ranges of the thresholds are learnable parameters, which are mapped by an additional neural network based on working condition parameters, and t is a temperature coefficient, which controls the smoothness of the band-pass cutoff of the threshold function.

Preferably, wherein, the wavelet coefficient after threshold processing is reconstructed by the learnable multi-band wavelet reconstruction network, and the reconstruction process for a single node is expressed as:

$$x = {\sum }_{m = 1}^{M} {\tilde{h}}_{m} * {w}_{m}^{′} ,$$

wherein, wₘ′ is the wavelet coefficient processed by the threshold function, \tilde{h}ₘ is a reconstruction filter corresponding to a decomposition filter hₘ, x is the reconstructed signal, and M is the number of filters used by the layer.

Preferably, wherein, the training process of the multi-band wavelet network includes the steps of:
S201: segmenting monitoring signals collected in a healthy state, dividing the segmented monitoring signals into a training set and a validation set, and labeling with corresponding working condition information labels;
S202: establishing a multi-band wavelet network, and optimization loss; and
S203: training the multi-band wavelet network with the training set, in response to determining that reconstruction loss on the validation set is minimized, completing the network training.

Preferably, wherein, in step S202, the optimization loss refers to training total loss Lₐₗₗ of the multi-band wavelet network, which is expressed as:

$${L}_{all} = {L}_{R} + α {L}_{F} + β {L}_{S} + γ {L}_{T} ,$$

wherein, L_{R} is reconstruction loss calculated from an error of the input signal x and the reconstructed signal x, L_{F} is a filter property constraint regularization term derived from the multi-band wavelet transform, L_{S} is an L1 sparsity regularization term of wavelet sparseness, L_{T} is a threshold contraction constraint term in the learnable wavelet thresholding bi-directional contraction function, and α, β, and γ are hyperparameters that can be optimized through grid search.

Preferably, wherein, the state monitoring index is calculated from the root mean square error of the input signal and the reconstructed signal.

Preferably, wherein, determining the threshold includes: taking a certain percentage of the maximum value of the state monitoring index as the threshold according to needs based on a statistical result of the state monitoring indexes of the monitoring signals of the aeroengine in a healthy state under a plurality of working conditions.

Preferably, wherein, determining that the state of the engine is abnormal in response to determining that the state monitoring indexes of the monitoring signals of the aeroengine to be tested under the plurality of working conditions are greater than the threshold for a plurality of consecutive times, and otherwise determining that the state of the engine is normal.

Compared with the prior art, the beneficial effects brought by the present disclosure are:

1. Compared to traditional methods, this disclosure fully considers the advantages and disadvantages of signal processing technology and deep learning networks for anomaly detection. By introducing wavelet transform, threshold denoising, and neural network fitting techniques, it combines the interpretability of signal processing with the data-driven capabilities of deep learning networks, thereby improving the noise resistance and robustness to changes in working conditions of the anomaly detection method.

2. Given the crucial role of the wavelet basis function in signal processing through wavelet transform, practical applications often require expert judgement to select the appropriate wavelet basis. By establishing learnable multi-band wavelet filters and the optimization constraint regularization term corresponding to the wavelet filters, the wavelet basis function can be learned adaptively, thereby reducing the reliance on expert experience.

3. Considering that wavelet transform decomposition and reconstruction can reconstruct any signal but cannot directly model the statistical characteristics of signals or identify abnormal signals, this disclosure designs a wavelet thresholding bi-directional contraction function to enable the multi-band wavelet network to adaptively fit the signal distribution characteristics across a plurality of frequency bands, effectively modeling the signal characteristics and thereby identifying abnormal signals.

4. Given that the determination of traditional wavelet thresholds is independent of working condition information, and the threshold design criteria rely on expert experience, making it difficult to determine thresholds under variable working conditions, this disclosure utilizes neural networks to adaptively learn the wavelet thresholds corresponding to each decomposition frequency band based on working condition information, thereby enhancing the robustness of the thresholds to changes in working conditions.

### BRIEF DESCRIPTION OF DRAWINGS

FIG. 1 is a flowchart illustrating a method for detecting anomalies in acroengine variable working conditions based on a multi-band wavelet network according to an embodiment of the present disclosure;

FIG. 2 is a schematic diagram of a multi-band wavelet network according to another embodiment of the present disclosure;

FIG. 3 is a schematic diagram of a wavelet thresholding bi-directional contraction function according to another embodiment of the present disclosure;

FIGS. 4A-D are schematic diagrams of a process for detecting typical abnormal signals using a multi-band wavelet network with a periodic signal and several typical abnormal signals according to another embodiment of the present disclosure; and

FIG. 5 is a schematic diagram comparing the abnormal detection performance of different networks under variable working conditions according to another embodiment of the present disclosure.

FIG. 6 is a schematic diagram of a multi-band wavelet network-based apparatus for detecting acroengine anomalies under variable working conditions according to another embodiment of the present disclosure; and

FIG. 7 is a schematic diagram of a multi-band wavelet network-based system for detecting aeroengine anomalies under variable working conditions according to another embodiment of the present disclosure;

### DETAILED DESCRIPTION OF THE DISCLOSURE

Specific embodiments of the present disclosure will be described in detail below with reference to the accompanying drawings. While specific embodiments of the present disclosure are illustrated in the drawings, it should be understood that the present disclosure may be embodied in various forms and should not be limited to the embodiments set forth herein. Rather, these embodiments are provided in order to enable a more thorough understanding of the present disclosure and to fully convey the scope of the present disclosure to those skilled in the art.

It should be noted that certain words are used in the specification and claims to refer to specific components. It will be understood by those skilled in the art that different terms may be used by those skilled in the art to refer to the same component. The present specification and claims do not use differences in terms as a way to distinguish components, but use differences in functions of components as a criterion for distinguishing them. For example, throughout the specification and claims, the terms “comprise” or “includes” or “including” or “comprising” are open-ended expressions and should be interpreted as “comprising/including/comprises/includes but not limited to”. The following description describes preferred embodiments for carrying out the present disclosure, but the description is for the purpose of general principles of description and is not intended to limit the scope of the present disclosure. The scope of the present disclosure is defined by the appended claims.

In order to facilitate an understanding of embodiments of the present disclosure, specific embodiments will now be further explained by way of example with reference to the accompanying drawings, which are not to be construed as limiting embodiments of the present disclosure.

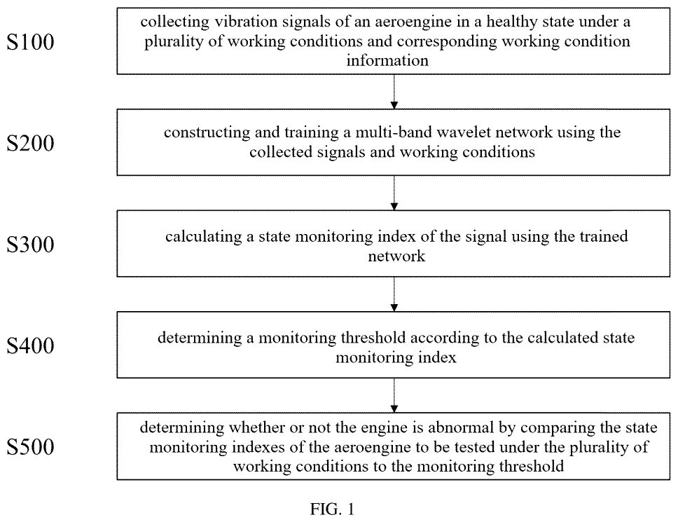

In one embodiment, as shown in FIG. 1, the present disclosure proposes a method for detecting anomalies in aeroengine variable working conditions based on a multi-band wavelet network, including the steps of:
S100: collecting monitoring signals of an aeroengine in a healthy state under a plurality of working conditions and corresponding working condition information, wherein,
monitoring signals e.g., vibration signals, pressure, temperature, etc. of an aeroengine in a healthy state under a plurality of working conditions, and corresponding working condition information e.g., rotor speed, flight height, flight speed, etc. are collected; among them, the various monitoring signals and operating/working condition information mentioned above can be obtained through corresponding sensors, or through systems such as the Engine Health Management (EHM) system and the Flight Data Recorder (FDR) system;
S200: constructing and training a multi-band wavelet network using the monitoring signals and working condition information;
S300: calculating a state monitoring index of the monitoring signal using the trained network;
S400: determining a monitoring threshold according to the state monitoring index; and
S500: determining whether or not the engine is abnormal by comparing the state monitoring indexes of the monitoring signals of the aeroengine under the plurality of working conditions to the monitoring threshold.

The above embodiments constitute complete technical solutions of the present disclosure. The present disclosure fully considers the advantages and disadvantages of the signal processing technique with the deep learning network for fault diagnosis, by introducing wavelet transform, threshold denoising, neural network fitting techniques, the signal processing is organically combined with the data driving capability of the deep learning network, thus improving the noise resistance and the working condition change robustness of the anomaly detection method.

In another embodiment, the constructed multi-band wavelet network (said in step S200 or training component 1002) includes:
a learnable multi-band wavelet decomposition network for acquiring wavelet coefficient representations of the signal at different scales by performing one-dimensional wavelet multi-scale decomposition on the collected signal;
a learnable wavelet thresholding bi-directional contraction function for achieving efficient identification and removal of anomalous coefficients and achieving suppression of noise in the signal by adaptively fitting a distribution range of wavelet coefficients generated by the multi-band wavelet decomposition network in combination with the working condition information; and
a learnable multi-band wavelet reconstruction network for acquiring a reconstructed signal by performing multi-band wavelet reconstruction on the wavelet coefficient processed by the wavelet thresholding bi-directional contraction function.

In another embodiment, the monitoring signal is subjected to one-dimensional wavelet convolution by the learnable multi-band wavelet decomposition network, a wavelet decomposition or wavelet packet decomposition mode is used, wherein the multi-band wavelet decomposition of a single node is expressed as:

$${w}_{m} = {h}_{m} * x , m = 1 , 2 , … , M$$

wherein, x is an input signal, i.e., a monitoring signal sample input after segmentation, w is the wavelet coefficient obtained by one-dimensional convolution, * denotes convolution, hₘ is a learnable wavelet filter satisfying the property requirement of multi-band wavelet transform, which is capable of adaptive learning based on the data, M is the number of filters used in the layer.

It should be noted that, M≥2, in contrast to conventional multi-band wavelet transform, the number of filters used in the wavelet decomposition of each layer of the wavelet network can be different, i.e., for 2-layer discrete multi-band wavelet decomposition, the number of filters used in the first layer is M₁, and the number of filters used in the second layer is M₂, M₁ and M₂ are independent and the optimum values need to be selected according to the monitoring object.

It should also be noted that the obtained wavelet coefficient wₘ needs to be down-sampled by a down-sampling factor, which is the number M of filters used for decomposition of the node, the down-sampling being expressed as:

$${w}_{m} ↓ [ n ] = {w}_{m} [ n M ] , n = 1 , 2 , 3 , … , L$$

wherein, n is the serial number of the coefficient, wₘ↓ is the down-sampled coefficient, and L is the length of the down-sampled wavelet coefficient.

In another embodiment, the wavelet coefficient is processed by the learnable wavelet thresholding bi-directional contraction function, which is expressed as:

$${w}^{′} = w [ [ σ ( - t ( w ↓ - l ) ) - σ ( - t ( w ↓ + ( - l + {b}_{l} ) ) ) + σ ( t ( w ↓ - r ) ) - σ ( t ( w ↓ - ( r + {b}_{r} ) ) ) ] ,$$

wherein, σ is a sigmoid activation function, w↓ is a down-sampled wavelet coefficient obtained by the multi-band wavelet decomposition network via the wavelet decomposition or wavelet packet decomposition mode, l is a left threshold point, bₗ is a band-pass range of a left threshold function, r is a right threshold point, bᵣ is a band-pass range of a right threshold function, the threshold points and the band-pass ranges of the thresholds are mapped by a neural network based on working condition parameters, and t is a temperature coefficient, which controls the approximation speed between the threshold function and the hard threshold denoising function.

It should be noted that for the wavelet coefficients of each frequency band, a set of corresponding threshold parameters l, bₗ, r, and bₗ need to be determined, and these parameters are obtained through a threshold learning network f(·) composed of three fully connected layers by mapping the working condition parameters, and can be expressed as

$$( l , {b}_{l} , r , {b}_{r} ) = f ( c ) = f c ( ρ ( f c ( ρ ( f c ( c ) ) ) ) )$$

wherein, c is the working condition parameter, fc is the fully connected layer, and ρ(·) is an activation layer composed of a ReLU activation function and a dropout function.

In another embodiment, the wavelet coefficient after processing by the wavelet thresholding bi-directional contraction function is multi-band wavelet reconstructed by the learnable multi-band wavelet reconstruction network, and the reconstruction process for a single node is expressed as:

$$x = {\sum }_{m = 1}^{M} {\tilde{h}}_{m} * {w}_{m}^{′} ,$$

wherein, wₘ′ is the wavelet coefficient processed by the wavelet thresholding bi-directional contraction function, \tilde{h}ₘ is a reconstruction filter corresponding to a decomposition filter hₘ, x is the reconstructed signal, and M is the number of filters used by the layer.

It should be noted that the relation between the reconstruction filter \tilde{h}ₘ and the corresponding decomposition filter hₘ is:

$${\tilde{h}}_{m} [ n ] = {h}_{m} [ - n ] , n = 1 , 2 , 3 , … , L$$

wherein, n denotes the serial number of an internal coefficient of the filter, and L is the filter length.

It should also be noted that the structure of the reconstruction network needs to be strictly symmetrical to the decomposed network.

It should also be noted that the wavelet coefficient wₘ′ need to be up-sampled before reconstruction, the sampling factor is the down-sampling factor M used in the decomposition process, the remaining coefficients of the interpolation are 0, and the up-sampling process is expressed as:

$$\{ \begin{matrix}{w}_{m} ↑ [ n M ] = {w}_{m}^{′} [ n ] , \\ {w}_{m} ↑ [ n M + 1 ] = 0 , \\ … \\ {w}_{m} ↑ [ n M + M - 1 ] = 0 ,\end{matrix} n = 1 , 2 , 3 , … , L$$

wherein n is the serial number of the coefficient, wₘ↑ is the coefficient after up-sampling, and L is the length of the single wavelet coefficient before reconstruction.

In another embodiment, the training process of the multi-band wavelet network (said in step S200 or training component 1002) includes the steps of:
S201: the monitoring signals (such as vibration signals, pressure, temperature, etc.) collected in a healthy state are segmented, the segmented monitoring signals are divided into a training set and a validation set, and corresponding working condition information labels are labeled;
S202: a multi-band wavelet network, and optimization loss are established; and
S203: the multi-band wavelet network is trained with the training set, in response to determining that reconstruction loss on the validation set is minimized, the network training is completed.

In another embodiment, the optimization loss refers to training total loss Lₐₗₗ of the multi-band wavelet network, which is expressed as:

$${L}_{all} = {L}_{R} + α {L}_{F} + β {L}_{S} + γ {L}_{T} ,$$

wherein, L_{F} is a filter property constraint regularization term derived from the multi-band wavelet transform, L_{S} is an L1 sparsity regularization term of wavelet sparseness, L_{T} is a threshold contraction constraint term in the learnable wavelet thresholding bi-directional contraction function, α, γ, and γ are hyperparameters optimized through grid search, and L_{R} is the reconstruction optimization term calculated from the error of the input signal x and the reconstructed signal x:

$${L}_{R} = \frac{1}{N} {\sum }_{i = 1}^{N} {( {x}_{i} - {\hat{x}}_{i} )}^{2} ,$$

wherein, the signal x is equal in length to the reconstructed signal x, which is N, i is the serial number of the signal point, xᵢ is the value of the i-th point of the signal x, and \hat{x}ᵢ is the value of the i-th point of the reconstructed signal \hat{x}.

It should be noted that for an M-band filter bank H∈□_{M×N} consisting of (h₁, h₂, h₃, . . . , h_{M-1},h_{M}), wherein N=MK, it is possible to split the bank into K matrices A of M×M:

$${A}_{k} = [ \begin{matrix}{h}_{1 , M ( k - 1 ) + 1} & {h}_{1 , M ( k - 1 ) + 2} & … & {h}_{1 , Mk} \\ {h}_{2 , M ( k - 1 ) + 1} & {h}_{2 , M ( k - 1 ) + 2} & … & {h}_{2 , Mk} \\ ⋮ & ⋮ & ⋱ & ⋮ \\ {h}_{M , M ( k - 1 ) + 1} & {h}_{M , M ( k - 1 ) + 2} & … & {h}_{M , Mk}\end{matrix} ] \qquad k = 1 , … , K$$

Then the filter constraint regularization term L_{F} for the M-band filter bank H∈□_{M×N} is expressed as:

$${L}_{F} = {\sum }_{l = 1}^{L} {( {S}^{l} e - \sqrt{M} {e}_{1} )}^{2} + ( {( {{P}^{l} ( {P}^{l} )}^{T} - I )}^{2} + {( {{Q}^{l} ( {Q}^{l} )}^{T} - I )}^{2} ) ,$$

wherein, I is the matrix of units and the representation of the remaining symbols is as follows

$$\begin{matrix}\begin{matrix}S = {\sum }_{k = 0}^{K} {A}_{k} , & e = {( 1 , 1 , … , 1 )}^{T} , & e = {( 1 , 0 , … , 0 )}^{T} ,\end{matrix} \\ P = [ \begin{matrix}{A}_{1} & {A}_{2} & … & {A}_{K} & & & \\ & {A}_{1} & {A}_{2} & … & {A}_{K} & & \\ & & … & … & … & … & \\ & & & {A}_{1} & {A}_{2} & … & {A}_{K}\end{matrix} ] , \\ Q = [ \begin{matrix}{A}_{1}^{T} & {A}_{2}^{T} & … & {A}_{K}^{T} & & & \\ & {A}_{1}^{T} & {A}_{2}^{T} & … & {A}_{K}^{T} & & \\ & & … & … & … & … & \\ & & & {A}_{1}^{T} & {A}_{2}^{T} & … & {A}_{K}^{T}\end{matrix} ] ,\end{matrix}$$

It should be also noted that the constraint L_{S} of the sparsity regularity is expressed as:

$${L}_{S} = \frac{1}{1 - L + {\sum }_{l = 1}^{L} {M}^{l}} ( {‖ {w}_{1}^{L} ‖}_{1} / {N}_{L} + {\sum }_{l = 1}^{L} {\sum }_{i = 2}^{{M}^{l}} {‖ {w}_{i}^{l} ‖}_{1} / {N}_{l} ) ,$$

wherein, Nₗ is the number of wavelet coefficients

$${w}_{i}^{l}$$

decomposed at the l-th layer, L is the total number of decomposed layers of the network, and M^{l} is the number of wavelet bands decomposed at the l-th layer.

It should also be noted that the threshold contraction loss acts to minimize the range of coefficients that pass through the current frequency band in the wavelet thresholding bi-directional contraction function, essentially by maximizing the distance of the threshold starting point from 0 while minimizing the passband range, which is expressed as:

$${L}_{T} = \frac{1}{D} {\sum }_{i = 1}^{D} ( {b}_{l , i}^{2} + {b}_{r , i}^{2} ) - σ ( \frac{1}{D} {\sum }_{i = 1}^{D} ( {r}_{i} - {l}_{i} ) ) ,$$

wherein, D is the number of frequency band nodes resulting from the last layer of decomposition, rᵢ and lᵢ are the thresholds of the i-th node, bᵣᵢ and bₗᵢ are the band-pass ranges corresponding to the coefficients of the i-th node.

In another embodiment, the state monitoring index (said in step S300 or calculating component 1003) R is calculated from the root mean square error of the input signal x and the reconstructed signal x, which is expressed as:

$$R = \frac{1}{N} {\sum }_{i = 1}^{N} {( {x}_{i} - {\hat{x}}_{i} )}^{2} ,$$

wherein, N is the length of signal, i is the serial number of the signal points, xᵢ is the value of the i-th point of the signal x, and \hat{x}ᵢ is the value of the i-th point of the reconstructed signal \hat{x}.

It should be noted that in the embodiments described above, the monitoring signal is illustrated using x as an example.

Further, the first monitoring signal can be the temperature of the aeroengine cooling system collected by the first temperature sensor, and this first monitoring signal is used as input signal x;
the second monitoring signal can be the N1 rotational speed of the aeroengine collected by the second rotational speed sensor, and this second monitoring signal is used as input signal y;
the third monitoring signal can be the N2 rotational speed of the aeroengine collected by the third rotational speed sensor, and this third monitoring signal is used as input signal z;
wherein, generally, N1 and N2 are the rotational speeds of the engine sections expressed as a percentage of a nominal value.

Therefore, the embodiments illustrated using monitoring signal x are equally applicable to scenarios using monitoring signal y and/or monitoring signal z. Various monitoring signals, including temperature, rotational speed, and vibration, correspond to their respective state monitoring indices and monitoring thresholds.

In another embodiment, determining the monitoring threshold (said in step S400 or threshold determination component 1004) includes: 95% of the maximum value of the state monitoring index is taken as the monitoring threshold based on statistical results of the state monitoring indexes of the monitoring signals of the aeroengine in a healthy state under a plurality of working conditions.

In another embodiment, determining whether or not the engine is abnormal by comparing the state monitoring indexes of the monitoring signals of the aeroengine under the plurality of working conditions to the monitoring threshold (said in step S500 or anomaly determination component 1005) is performed by determining that the state of the engine is abnormal when the state monitoring indexes of the monitoring signals of the aeroengine to be tested under the plurality of working conditions are greater than the monitoring threshold for a plurality of consecutive 10 times, and otherwise determining that the state of the engine is normal.

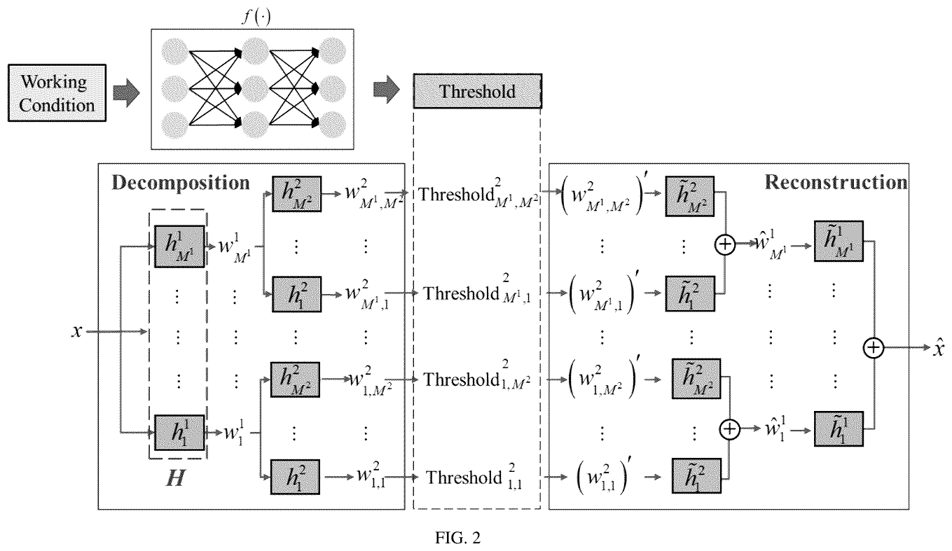

The disclosed techniques are further described below in connection with FIGS. 2-5:

FIG. 2 is a multi-band wavelet network structure designed by the present disclosure. The signal x is subjected to multi-band wavelet decomposition by passing through a filter bank H which includes M filters to obtain M wavelet coefficients

$$[ {w}_{{M}^{1}}^{1} , {w}_{{M}^{1} - 1}^{1} , … , {w}_{1}^{1} ] .$$

The right superscript 1 represents the first layer of decomposition and the right subscript represents the serial number of the wavelet coefficient obtained by decomposition. The decomposition number in each layer may be different, e.g., the number of filters in the filter bank used in the second layer is M². The working condition parameters c are mapped through a network f(·) consisting of three fully connected layers into a set of thresholds that vary according to the working conditions (Threshold is the set of parameters consisting of the threshold points [l,r] and band-pass ranges [bₗ, bᵣ] required by the wavelet thresholding bi-directional contraction function)

$$[ Thres {hold}_{1 , 1}^{2} , … , {Threshold}_{1 , {M}^{2}}^{2} , … , {T hreshold}_{{M}^{1} , 1}^{2} , … , {Threshold}_{{M}^{1} , {M}^{2}}^{2} ] .$$

As shown, each decomposed wavelet coefficient W has its corresponding set of threshold parameters. The multi-band wavelet network then processes the wavelet coefficient w using the wavelet thresholding bi-directional contraction function according to Threshold, i.e., the obtained set of threshold parameters. The reconstruction network is strictly symmetric to the decomposition network, the filter bank \tilde{h} is used to reconstruct the signals layer by layer to obtain the corresponding reconstruction coefficients

$$[ {\hat{w}}_{{M}^{1}}^{1} , {\hat{w}}_{{M}^{1} - 1}^{1} , … , {\hat{w}}_{1}^{1} ]$$

and finally obtain the reconstructed signal \hat{x}.

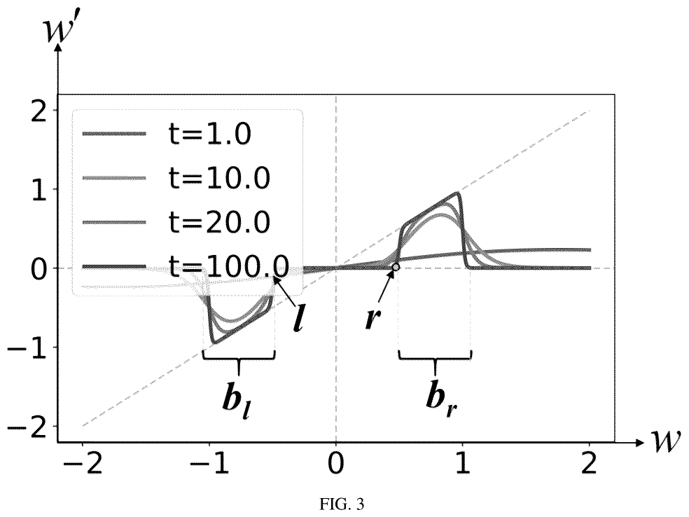

FIG. 3 is a schematic diagram of a wavelet thresholding bi-directional contraction function designed by the present disclosure. The input is the wavelet coefficient w and the output is the coefficient w′ after threshold processing. Within the band-pass interval composed of bᵣ and bₗ, the relationship between the input coefficient and the output coefficient is approximately y=x. When the temperature parameter t is smaller, the mapping is smoother, and the output value at the threshold point is closer to 0. This function ensures that only the wavelet coefficients in the band-pass interval are retained, while the coefficients in the remaining intervals are set to zero.

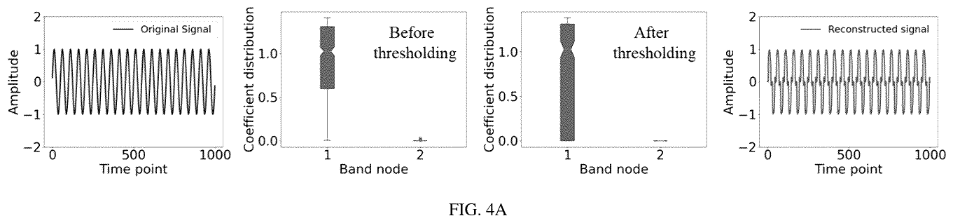

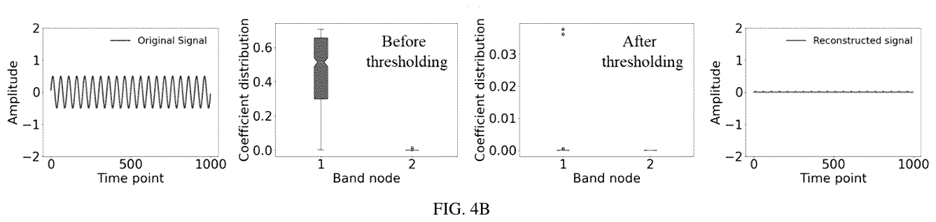

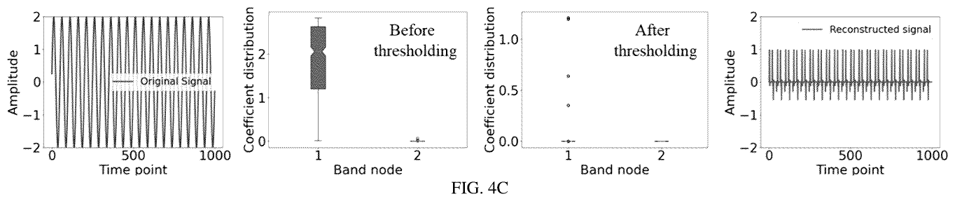

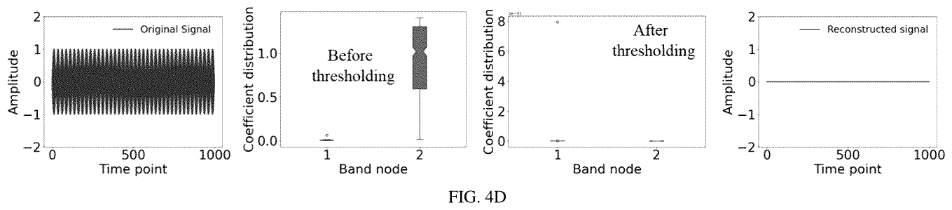

FIGS. 4A-D are schematic diagrams of a process for detecting typical abnormal signals using a multi-band wavelet network with a periodic signal and several typical abnormal signals, and each subfigure is a detection flow of the multi-band wavelet network sequentially from left to right. In each subfigure: the first image from the left is the time-domain plot of the input signal. The second image shows the amplitude distribution characteristics of the intermediate wavelet coefficients generated by a single-layer 2-band wavelet decomposition network across different frequency bands (labeled with band node numbers). The third image shows the amplitude distribution characteristics of the intermediate wavelet coefficients across different frequency bands after being processed by the output threshold of the wavelet thresholding bi-directional contraction function. The fourth image shows the reconstructed signal obtained by passing the wavelet coefficients in the third image through a single-layer 2-band wavelet reconstruction network.

FIG. 4A is a periodic signal. The second image from left to right in FIG. 4A shows the amplitude distribution of wavelet coefficients obtained by passing the periodic signal through a wavelet decomposition network. These coefficients are primarily distributed at the frequency band node 1, exhibiting a distribution characteristic of being centered around 1.0, with no distribution at the frequency band node 2. After processing with the wavelet thresholding bi-directional contraction function, the distribution at the frequency band node 1 undergoes slight changes, but the distribution characteristic remains being centered around 1.0, and there is still no distribution at the frequency band node 2. Consequently, the reconstructed signal is similar to the original signal, resulting in a low reconstruction error.

FIG. 4B represents an abnormal signal with a relatively low amplitude. The second image from left to right in FIG. 4B displays the amplitude distribution of wavelet coefficients obtained by passing the abnormal signal through the wavelet decomposition network. These coefficients are primarily distributed at the frequency band node 1, centered around 0.5, with no distribution at the frequency band node 2. After processing with the wavelet thresholding bi-directional contraction function, since the coefficients fall outside the pass-band range of the threshold function, the coefficient distribution in the third image is essentially set to zero. This makes it difficult to reconstruct the original signal from the coefficients processed by the threshold function, resulting in a reconstructed signal that is a straight line with a significantly large reconstruction error.

FIG. 4C represents an abnormal signal with a relatively high amplitude. The second image from left to right in FIG. 4C of shows the amplitude distribution of wavelet coefficients obtained by passing the abnormal signal through the wavelet decomposition network. These coefficients are primarily distributed at the frequency band node 1, centered around 2.0, with no distribution at the frequency band node 2. After processing with the wavelet thresholding bi-directional contraction function, since most of the coefficients fall outside the pass-band range of the threshold, only a portion of the coefficients are retained. The reconstructed signal has a maximum amplitude of 1, which is significantly lower than the original signal's maximum amplitude of 2, resulting in a relatively large reconstruction error.

FIG. 4D represents an abnormal signal with a relatively high frequency. The second image from left to right in FIG. 4D displays the amplitude distribution of wavelet coefficients obtained by passing the abnormal signal through the wavelet decomposition network. These coefficients are primarily distributed at the frequency band node 2, centered around 1.0. Due to the inconsistency in the distribution node compared to the normal signal, after processing with the wavelet thresholding bi-directional contraction function, all coefficients are set to zero. The reconstructed signal is a straight line, resulting in a significantly large reconstruction error. The reconstruction error can easily be used to determine whether the signal is periodic or not. Since the detection process of the multi-band wavelet network can be fully explained from the perspective of wavelet coefficient distribution, this strong interpretability makes the network more suitable for health monitoring of aero-engines.

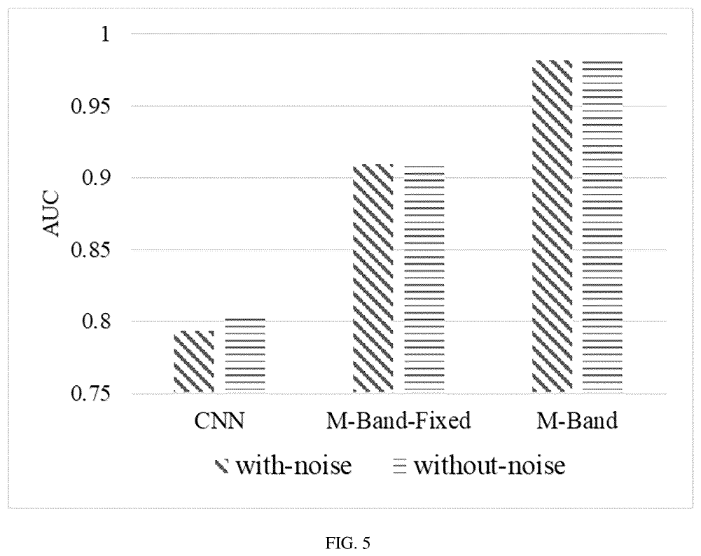

FIG. 5 is a schematic diagram comparing the abnormal detection performance of different networks under variable working conditions. It contrasts the autoencoder anomaly detection network composed of a traditional Convolutional Neural Network (CNN), an M-Band-Fix wavelet network that does not introduce working condition information, and an M-Band multiband wavelet network that introduces working condition information and learns thresholds through the network. Firstly, by comparing the detection results with and without noise, the multiband wavelet network structure exhibits stronger noise robustness. Compared to the CNN network, both M-Band and M-Band-Fix experience minimal degradation in detection performance when noise is present. Compared to the M-Band-Fix wavelet network that does not introduce the working condition information, its lack of consideration for variable working conditions and the absence of introducing the working condition information into the network result in poorer anomaly detection capability under a plurality of working conditions. The M-Band wavelet network, which maps thresholds based on working condition information learned by the network, outperforms the M-Band-Fix that does not introduce such information. The M-Band designed in this disclosure is more robust to changes in working conditions.

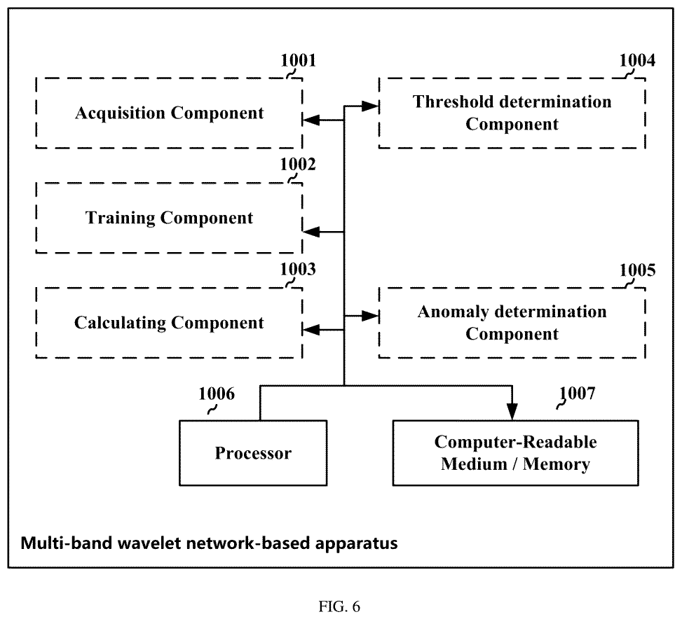

In another embodiment, as shown in FIG. 6, the present disclosure also reveals a multi-band wavelet network-based apparatus for detecting aeroengine anomalies under variable working conditions, comprising:
an acquisition component 1001, for collecting monitoring signals of an aeroengine in a healthy state under a plurality of working conditions and corresponding working condition information, wherein,
monitoring signals (e.g., vibration signals, pressure, temperature, etc.) of an aeroengine in a healthy state under a plurality of working conditions and corresponding working condition information (e.g., rotor speed, flight height, flight speed, etc.) are collected; among them, the various monitoring signals and operating/working condition information mentioned above can be obtained through corresponding sensors, or through systems such as the Engine Health Management (EHM) system and the Flight Data Recorder (FDR) system;
a training component 1002, for constructing and training a multi-band wavelet network using the monitoring signals and working condition information;
a calculating component 1003, for calculating a state monitoring index of the monitoring signal using the trained network;
a threshold determination component 1004, for determining a monitoring threshold according to the state monitoring index; and
an anomaly determination component 1005, for determining whether or not the engine is abnormal by comparing the state monitoring indexes of the monitoring signals of the aeroengine under the plurality of working conditions to the monitoring threshold.

It should be noted that the components may be one or more hardware components specifically configured to carry out the stated processes/algorithm, implemented by a processor 1006 configured to perform the stated processes/algorithm, stored within a computer-readable medium/memory 1007 for implementation by a processor 1006, or some combination thereof.

It should be understood that once the multi-band wavelet network is trained, the apparatus for detecting aeroengine anomalies under variable working conditions does not require the deployment of training component 1002 during deployment. Instead, only acquisition component 1001, calculating component 1003, threshold determination component 1004, and anomaly determination component 1005 need to be deployed to detect anomalies in the target aeroengine under variable working conditions.

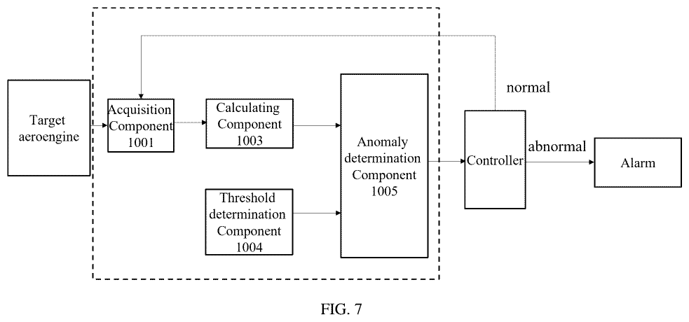

Furthermore, as shown in FIG. 7, in another embodiment, the present disclosure also reveals a multi-band wavelet network-based system for detecting aeroengine anomalies under variable working conditions, comprising:
a target aeroengine of the same type as the one in a healthy state,
the apparatus for detecting aeroengine anomalies under variable working conditions, and
a controller,
wherein,
acquisition component 1001 is further used to collect monitoring signals and corresponding working/operating condition information from the target aeroengine under various operating conditions; for example, it collects monitoring signals such as vibration signals, pressure, temperature, and corresponding operating condition information such as rotor speed, flight altitude, and flight speed; the various monitoring signals and operating condition information mentioned above can be obtained through corresponding sensors or through the aeroengine health management system (EHM), flight data recorder (FDR) system, etc;
calculating component 1003 is further used to: take the monitoring signals and corresponding operating condition information collected by acquisition component 1001 as input, and use the trained network to calculate the state monitoring index of the monitoring signals;
anomaly determination component 1005 is further used to: based on the state monitoring index calculated by calculating component 1003 and the monitoring threshold determined by threshold determination component 1004, compare the state monitoring index with the monitoring threshold to determine whether the engine is abnormal, and send the judgment result to the controller, wherein,
when the judgment result is normal, the controller sends a first signal to acquisition component 1001 to continue the detection of anomalies in the target aeroengine under variable working conditions;
when the judgment result is abnormal, the controller sends a second signal to an alarm to trigger an alert.

Although the present disclosure and embodiments have been described in detail with reference to the accompanying drawings, the present disclosure is not limited to the above-described specific embodiments and application fields, and various forms of substitutions and modifications made to the patents of the present disclosure are protected by the present disclosure without departing from the principles and spirit of the present disclosure.

1. A method for detecting anomalies in aeroengine variable working conditions based on a multi-band wavelet network, comprising the steps of:
S100: collecting monitoring signals of an aeroengine in a healthy state under a plurality of working conditions and corresponding working condition information;
S200: constructing and training a multi-band wavelet network using the monitoring signals and working condition information;
S300: calculating a state monitoring index of the monitoring signal using the trained multi-band wavelet network;
S400: determining a monitoring threshold according to the state monitoring index; and
S500: determining whether or not the engine is abnormal by comparing the state monitoring indexes of the monitoring signals of the aeroengine under the plurality of working conditions to the monitoring threshold.

2. The method according to claim 1, wherein, in step S200, the multi-band wavelet network comprises:
a learnable multi-band wavelet decomposition network for acquiring wavelet coefficient representations of the monitoring signal at different scales by performing one-dimensional wavelet multi-scale decomposition on the monitoring signal;
a learnable wavelet thresholding bi-directional contraction function for achieving efficient identification and removal of anomalous coefficients and achieving suppression of noise in the signal by adaptively fitting a distribution range of wavelet coefficients generated by the multi-band wavelet decomposition network in combination with the working condition information; and
a learnable multi-band wavelet reconstruction network for acquiring a reconstructed signal by performing multi-band wavelet reconstruction on the wavelet coefficient processed by the wavelet thresholding bi-directional contraction function.

3. The method according to claim 2, wherein the monitoring signal is subjected to one-dimensional wavelet convolution by the learnable multi-band wavelet decomposition network, a wavelet decomposition or wavelet packet decomposition mode is used, wherein the multi-band wavelet decomposition of a single node is expressed as:
$${w}_{m} = {h}_{m} * x , \qquad m = 1 , 2 , … , M ,$$
wherein, x is an input signal, i.e., a monitoring signal sample input after segmentation, w is the wavelet coefficient obtained by one-dimensional convolution, * denotes convolution, hₘ is a learnable wavelet filter satisfying the property requirement of multi-band wavelet transform, which is capable of adaptive learning based on the data, and M is the number of filters used in the layer.

4. The method according to claim 2, wherein the wavelet coefficient is processed by the learnable wavelet thresholding bi-directional contraction function, which is expressed as:
$${w}^{′} = w [ [ σ ( - t ( w ↓ - l ) ) - σ ( - t ( w ↓ + ( - l + {b}_{l} ) ) ) + σ ( t ( w ↓ - r ) ) - σ ( t ( w ↓ - ( r + {b}_{r} ) ) ) ] ,$$
wherein, σ is a sigmoid activation function, w↓ is a down-sampled wavelet coefficient obtained by the multi-band wavelet decomposition network via the wavelet decomposition or wavelet packet decomposition mode, l is a left threshold point, bₗ is a band-pass range of a left threshold function, r is a right threshold point, bᵣ is a band-pass range of a right threshold function, the threshold points and the band-pass ranges of the thresholds are learnable parameters, which are mapped by an additional neural network based on working condition parameters, and t is a temperature coefficient, which controls the smoothness of the band-pass cutoff of the threshold function.

5. The method according to claim 2, wherein the wavelet coefficient after threshold processing is multi-band wavelet reconstructed by the learnable multi-band wavelet reconstruction network, and the reconstruction process for a single node is expressed as:
$$x = {\sum }_{m = 1}^{M} {\tilde{h}}_{m} * {w}_{m}^{′} ,$$
wherein,
$${w}_{m}^{′}$$
is the wavelet coefficient processed by the threshold function, \tilde{h}ₘ is a reconstruction filter corresponding to a decomposition filter hₘ, x is the reconstructed signal, and M is the number of filters used by a reconstruction layer.

6. The method according to claim 1, wherein, in step S200, the training process of the multi-band wavelet network comprises the steps of:
S201: segmenting the monitoring signals collected in a healthy state, dividing the segmented monitoring signals into a training set and a validation set, and labeling with corresponding working condition information labels;
S202: establishing a multi-band wavelet network, and optimization loss; and
S203: training the multi-band wavelet network with the training set according to the optimization loss, in response to determining that reconstruction loss on the validation set is minimized, completing the network training.

7. The method according to claim 6, wherein, in step S202, the optimization loss refers to training total loss Lₐₗₗ of the multi-band wavelet network, which is expressed as:
$${L}_{a l l} = {L}_{R} + α {L}_{F} + β {L}_{S} + γ {L}_{T} ,$$
wherein, L_{R} is a reconstruction optimization term calculated from an error of the input signal x and the reconstructed signal x, L_{F} is a filter property constraint regularization term derived from the multi-band wavelet transform, L_{S} is an L1 sparsity regularization term of wavelet sparseness, L_{T} is a threshold contraction constraint term in the learnable wavelet thresholding bi-directional contraction function, and α, β, and γ are hyperparameters.

8. The method according to claim 1, wherein, in step S300, the state monitoring index is calculated from a root mean square error of the input signal X and the reconstructed signal x.

9. The method according to claim 1, wherein, in step S400, determining the monitoring threshold comprises: taking a certain percentage of the maximum value of the state monitoring index as the monitoring threshold according to actual needs based on a statistical result of the state monitoring indexes of the monitoring signals of the aeroengine in a healthy state under a plurality of working conditions.

10. The method according to claim 1, wherein, in step S500, the comparison is performed by determining that the state of the engine is abnormal in response to determining that the state monitoring indexes of the monitoring signals of the aeroengine to be tested under the plurality of working conditions are greater than the monitoring threshold for a plurality of consecutive times, and otherwise determining that the state of the engine is normal.
